(19) United States
(12) Patent Application Publication
(10) Pub. No.: US 2008/0055495 A1
(43) Pub. Date: Mar. 6, 2008

(54) LCD panel with synchronized integral touchscreen

(75) Inventor: Andrei Cernasov, Ringwood, NJ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC.

(21) Appl. No.: 11/515,011

(22) Filed: Sep. 5, 2006

(51) Int. Cl. G02F 1/1335

(52) U.S. Cl. 349/12

(57) ABSTRACT

A liquid crystal display (LCD) device (100) having an integrated touchscreen, includes a touchscreen surface and liquid crystal (LC) layer (20) that are partitioned according to the touchscreen keys (200). A probe signal source (82) is disposed within the device for transmitting a probe signal through an opening in the LC layer, toward the touchscreen surface. The device further includes a probe signal sensor (92, 92′) configured to sense reflections of the probe signal from the touchscreen surface, in order to detect user contact. In order to determine which particular touchscreen key is being touched, the probe signal opening scans through the set of keys one at a time.

### CROSS-REFERENCES TO RELATED APPLICATIONS

The present invention is related to co-pending U.S. patent application Ser. No. ______, entitled “LCD PANEL WITH INTEGRAL TOUCHSCREEN,” which was filed on ______, and copending U.S. patent application Ser. No. ______, entitled “LCD TOUCHSCREEN PANEL. WITH SCANNING BACKLIGHT,” which was filed on ______. The entire contents of the above-identified related applications are hereby incorporated by reference in their entirety.

### FIELD OF THE INVENTION

The present invention relates to a liquid crystal display (LCD) panel with an integrated touchscreen, and more particularly, to equipping the LCD panel with a sensor for detecting user contact with a particular touchscreen key.

### BACKGROUND OF THE INVENTION

For many types of interactive applications, touchscreens are ideal interface devices. This is because they are intuitive, reprogrammable, and capable of being environmentally sealed. Also, touchscreens occupy a relatively small amount of space. Thus, it would be desirable to incorporate touchscreen functionality in applications utilizing liquid crystal display (LCD) panels.

The configuration of a typical LCD device is illustrated in FIGS. 1A and 1B. As shown in FIG. 1A, a typical LCD device 1 includes a liquid crystal (LC) layer 20 sandwiched between two polarizing filters 30A and 30B (hereafter “polarizers”). The LC layer is protected by a transparent front protective sheet 10, e.g., a glass plate. For a backlit LCD device 1, behind the LC and polarizing layers are a light diffusing film 40 (hereafter “diffuser”), a backlight source 50, and a reflective surface 60. However, in a reflective-type LCD device 1, the diffuser 40 and backlight source 50 would be omitted (thus, these layers are illustrated by dotted lines in FIG. 1A). A casing or enclosure 70 is provided to hold the aforementioned layers in place. FIG. 1B illustrates an exploded view of the stack of LCD layers described above. The specification may collectively refer to these layers as the “LCD stack” of a backlit LCD device (including diffuser 40 and backlight source 50) or a reflective-type LCD device (without diffuser 40 or backlight source 50).

In a typical backlit LCD device (also referred to as a “transmissive” LCD device), the backlight is emitted directly from source 50 and reflected from reflective surface 60 to the diffuser 40. The diffuser 40 diffuses this light to make the intensity or brightness more uniform across the LCD. Polarizers 30A and 30B are cross-polarized with respect to each other.

Thus, the backlight polarized by polarizer 30B must be rotated to some extent by LC layer 20 in order to pass through polarizer 30A. The degree to which the LC layer 20 rotates the light is dependent upon the amount of voltage applied across the various liquid crystal molecules in the LC layer 20. For instance, a pair of electrodes (not shown) may be positioned across each LC cell to apply an appropriate voltage to “twist” the corresponding LC molecules, thereby rotating the backlight to pass through. In backlit LCD devices, numbers and characters are displayed according to the LC cells that allow light to pass through polarizers 30A and 30B.

FIGS. 2A and 2B illustrate the different types of backlight sources 50 that can be implemented in a typical backlit LCD device 1. Specifically, FIG. 2A illustrates a side view of a backlit LCD device 1, while FIG. 2B shows a cross-sectional view at CV.

As illustrated in FIGS. 2A and 2B, the backlight source 50 may include a combination of “pinpoint” light sources 52 (e.g., LED lamps) and/or cold cathode fluorescent lamps (CCFLs) 56. Furthermore, different types of diffusers 40 may be used. For instance, these figures show an edge-lit light guide/diffuser 44 dedicated specifically to the pinpoint LED sources 52. Also, a light-diffusing sheet 42 may be implemented in front of the CCFL sources 56.

As shown in FIGS. 2A and 2B, the pinpoint light sources 52 are configured to emit light into the edge-lit light guide/diffuser 44, which is situated parallel to the LC layer 20. As such, the edge-lit light guide/diffuser 44 is intended to distribute the light from the pinpoint light sources 52 more uniformly. The combination of the edge-lit light guide/diffuser 44 and LED light sources 52 is generally referred to as an LED edge-lit light guide assembly.

However, as mentioned above, an alternative to backlit LCD devices are reflective-type LCDs. In a reflective-type LCD device, the LC layer 20 is illuminated by external light. Referring again to FIGS. 1A and 1B, after passing through the LC layer 20 and polarizers 30A and 30B, the external light is reflected (and optionally diffused) by the reflective surface 60 back to the viewer. In such devices, the cells in the LC layer 20 are configured, by default, to allow light to pass through. Thus, numbers and characters are displayed using LC cells, which are charged by electrodes (not shown) to block light from passing through polarizers 30A and 30B.

Generally, previous attempts to utilize a touchscreen in conjunction with an LCD panel (backlit or reflective-type) require additional panels or layers to be added to the front protective sheet of the LCD device. This is disadvantageous because it reduces the amount of output light from the LCD, increases the complexity of the resultant device, and reduces overall system reliability.

### SUMMARY OF THE INVENTION

Exemplary embodiments of the present invention are directed to a liquid crystal display (LCD) device with an integrated touchscreen, in which a probe signal source and probe signal sensing device are built within the LCD stack behind the liquid crystal (LC) layer. The probe signal source is configured to transmit the probe signal through the LC layer and the touchscreen surface. Thus, when the probe signal sensing device detects a reflection of the probe signal from the touchscreen surface, the LCD device determines that a user has made contact with the touchscreen surface.

In an exemplary embodiment, the touchscreen surface is partitioned according to a plurality of touchscreen keys from which the user may choose. When user contact is detected, the LCD device further determines which of the touchscreen keys has been touched based on which particular key is “active” when detection occurs. The touchscreen keys are made active, one at a time, according to a scanning or timesharing scheme. Accordingly, during the interval where a particular key is active, the other keys are rendered inactive. Thus, the LCD device can distinguish between user contact with different keys through the use of a single probe signal sensor.

According to an exemplary embodiment, the LC layer may be partitioned according to the touchscreen keys. To make a particular key active, an “opening” is provided at the corresponding partition of the LC layer. This opening allows the probe signal to pass through the LC layer to the touchscreen surface. If the user is touching the corresponding key when the opening is provided, the probe signal sensing device is strategically placed to sense a reflection of the probe signal.

Furthermore, the LCD device may operate according to two interleaved modes: normal display mode and touchscreen mode. In normal display mode, the LCD device operates to display the touchscreen contents (keys, etc.) to the user. In touchscreen mode, on the other hand, the device performs touchscreen detection in accordance with the scanning or timesharing scheme.

Specifically, during touchscreen mode, the probe signal opening is provided to each touchscreen key according to the scanning or timesharing process. Since the probe signal source is active throughout this process, the probe signal in essence “scans through” the set of keys. If the user makes contact with a particular key, this contact will cause a reflection of the probe signal during the interval at which the opening is provided to that particular key. Accordingly, a determination may be made as to which key has been touched based on the interval during which the reflected probe signal is detected.

During touchscreen mode, the partitions of the LC layer may be made, by default, opaque. The probe signal opening is provided to each touchscreen key by switching the corresponding partition of the LC layer from opaque to transparent, thereby allowing the probe light source to transmit through the LC layer toward the active key on the touchscreen surface. Since the non-active keys remain opaque.

According to an exemplary embodiment, the probe signal source may be comprised of a light source modulated at a particular frequency range. Thus, the probe signal sensing device may comprise a light sensor for demodulating light in the same range, and producing an intensity measurement of this probe light. When the measured intensity increases (e.g., above a certain threshold), a determination is made that the user is touching a particular touchscreen key, thus causing the probe light to reflect to the probe light sensor. According to alternative embodiments, the probe light sensor may be implemented behind the LCD stack, or external to the touchscreen surface.

Further aspects in the scope of applicability of the present invention will become apparent from the detailed description provided below. However, it should be understood that the detailed description and the specific embodiments therein, while disclosing exemplary embodiments of the invention, as provided for purposes of illustration only.

### BRIEF DESCRIPTION OF THE DRAWINGS

A more complete understanding of the present invention will become apparent from the following description taken in conjunction with the accompanying drawings, which are given by way of illustration only and, thus, are not limitative of the present invention. In these drawings, similar elements are referred to using similar reference numbers, wherein:

FIGS. 1A and 1B illustrate the configuration of a typical liquid crystal display (LCD) device;

FIGS. 2A and 2B illustrate different types of backlight sources within typical backlit LCD devices;

FIG. 3 illustrates an exemplary set of touchscreen keys for a particular application;

FIGS. 4A and 4B illustrate an exemplary embodiment of the present invention in which the probe light sensor is disposed within the LCD stack along with the probe light source, while FIGS. 4C and 4D illustrate principles of operation in such an embodiment;

FIGS. 5A-5C illustrate an exemplary embodiment of the present invention utilizing an external probe light sensor in conjunction with a probe light source implemented within the LCD stack, while FIGS. 5D and 5E illustrate principles of operation in such an embodiment;

FIGS. 6A and 6B illustrate the scanning process whereby the touchscreen keys are made active, according to an exemplary embodiment of the present invention;

FIGS. 7A and 7B illustrate scanning patterns whereby touchscreen keys are made active, according to alternative exemplary embodiments of the present invention;

FIGS. 8A and 8B illustrate operation of a backlit LCD device during touchscreen mode and normal display mode, respectively, according to an exemplary embodiment of the present invention; and

FIGS. 9A and 9B illustrate additional elements in the LCD device for processing measurements from the probe light sensor and compensating for the effects of ambient light, according to exemplary embodiments of the present invention.

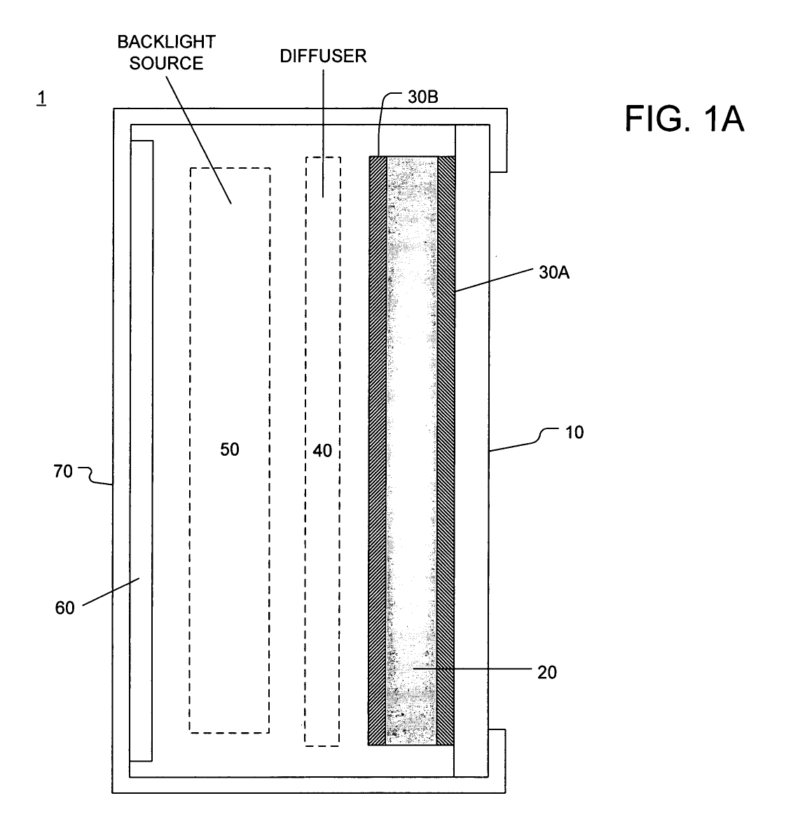

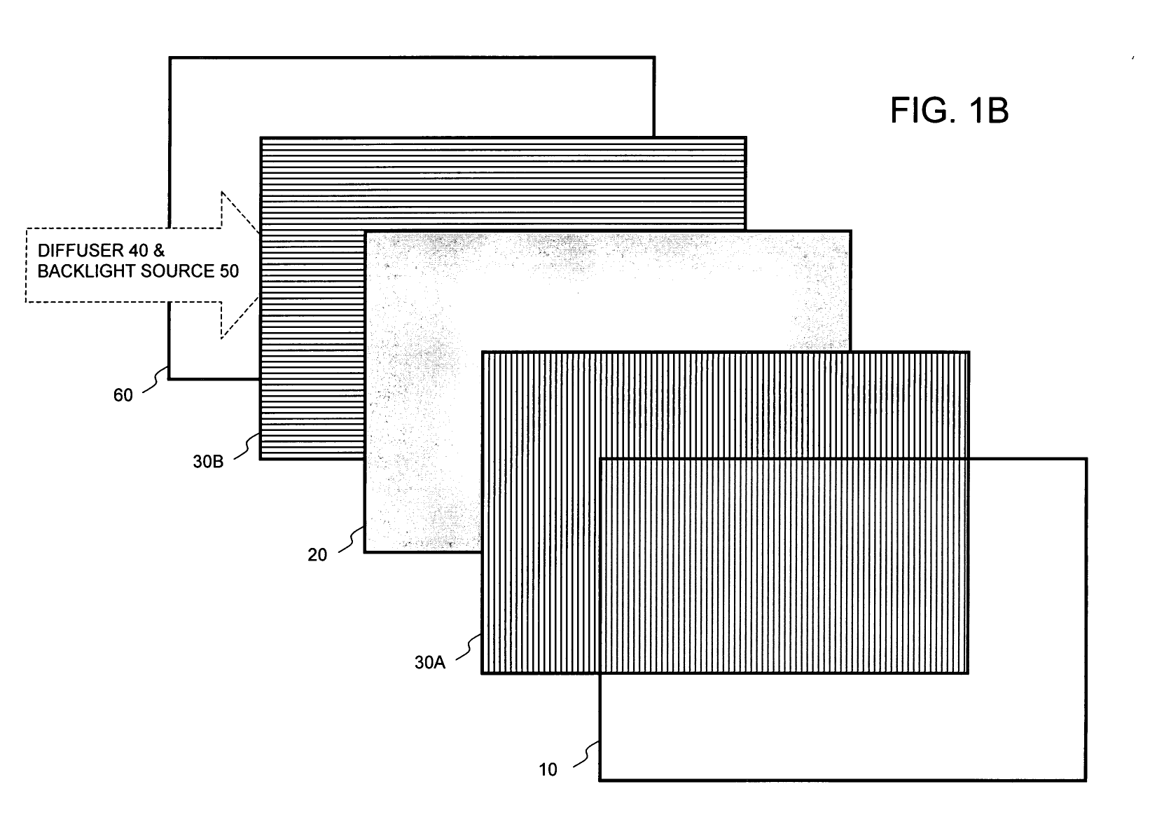

### DETAILED DESCRIPTION OF EXEMPLARY EMBODIMENTS

In order to integrate a touchscreen interface with a liquid crystal display (LCD) device, the present invention utilizes probe signals transmitted from within the stack of LCD layers to detect user contact with the touchscreen surface (e.g., the front protective sheet of the LCD device). A probe signal sensing device is configured to detect reflections of probe signals from the touchscreen surface, which are caused by a user's touch.

According to an exemplary embodiment, the source of the probe signals is a light source (hereafter “probe light source”), e.g., an LED, implemented behind the liquid crystal (LC) layer within the LCD casing or enclosure. Thus, the probe signal sensing device may comprise a light sensor (hereafter “probe light sensor”) configured to produce intensity measurements of the probe light. To enhance detection properties, the probe light source may be modulated at a particular frequency or range of frequencies, and the probe light sensor may be configured to demodulate and measure such light.

The probe light sensor may be disposed within the LCD stack, or external to the touchscreen surface, according to alternative exemplary embodiments. In either case, the probe light sensor is positioned such that user contact on the touchscreen surface causes some of the probe light to reflect toward the sensor. Since the reflected probe light causes the intensity measurement at the probe light sensor to increase, the probe light sensor may be used for detecting the user contact.

According to a further exemplary embodiment, the touchscreen surface may be partitioned into a plurality of touchscreen keys. It is contemplated that many different types of touchscreen applications could be implemented on the same LCD device. The type of touchscreen keys presented to the user, and configuration (size, shape, etc.) are purely a matter of design choice and the requirements of a given touchscreen application.

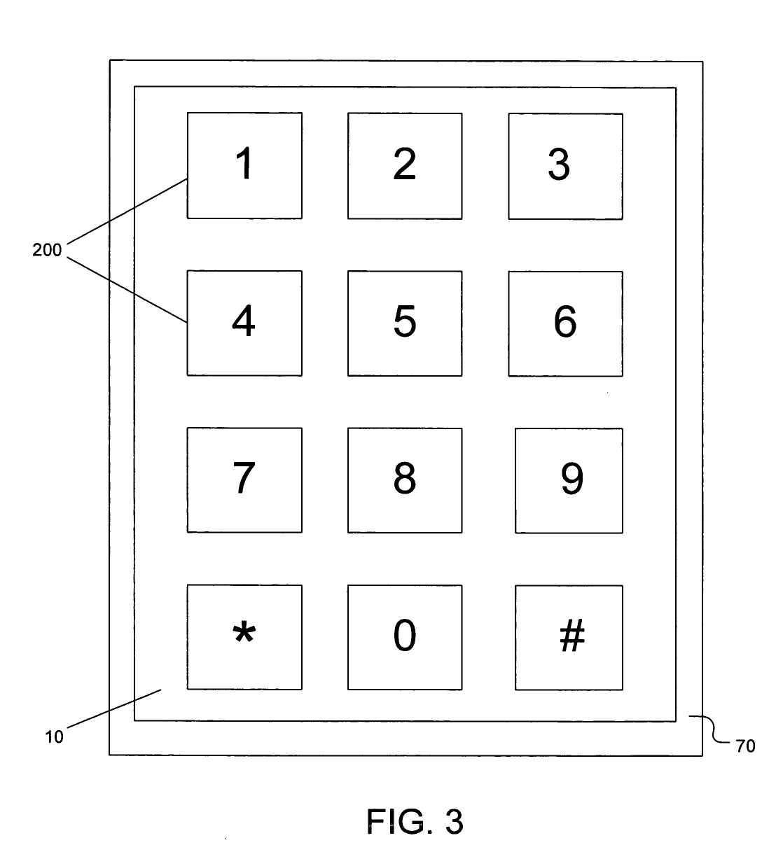

FIG. 3 illustrates a particular example of a touchscreen application where the user is presented with touchscreen keys 200 corresponding to traditional numerical keys of a push-button telephone. As shown in FIG. 3, the front protective sheet 10 of an LCD device may be used as the touchscreen surface. Of course, the touchscreen application illustrated in FIG. 3 is purely exemplary, merely providing a point of reference to describe further aspects of the invention.

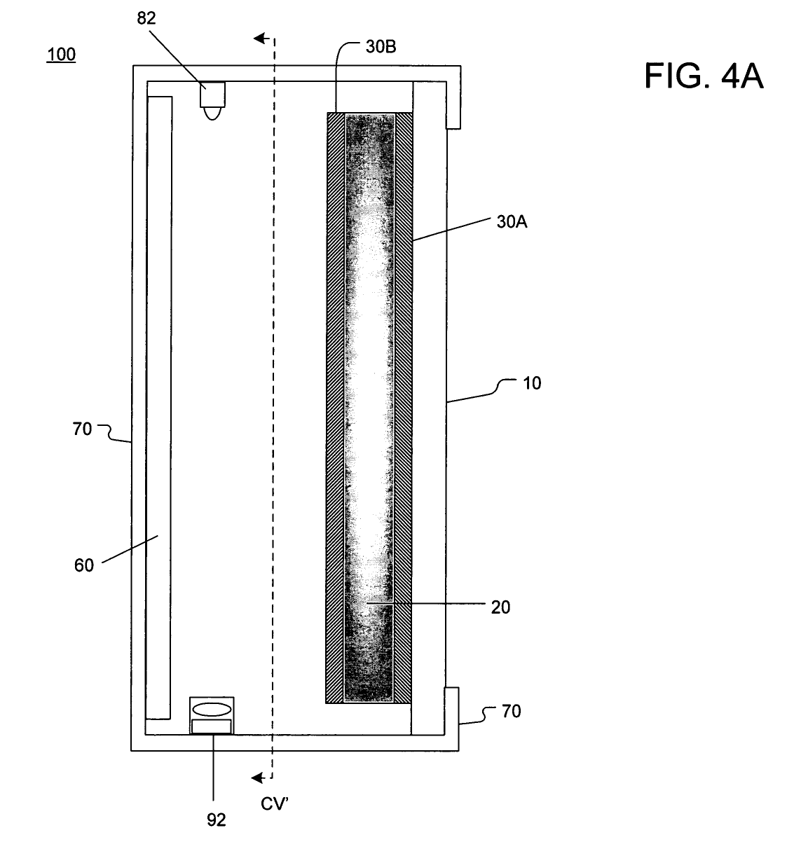

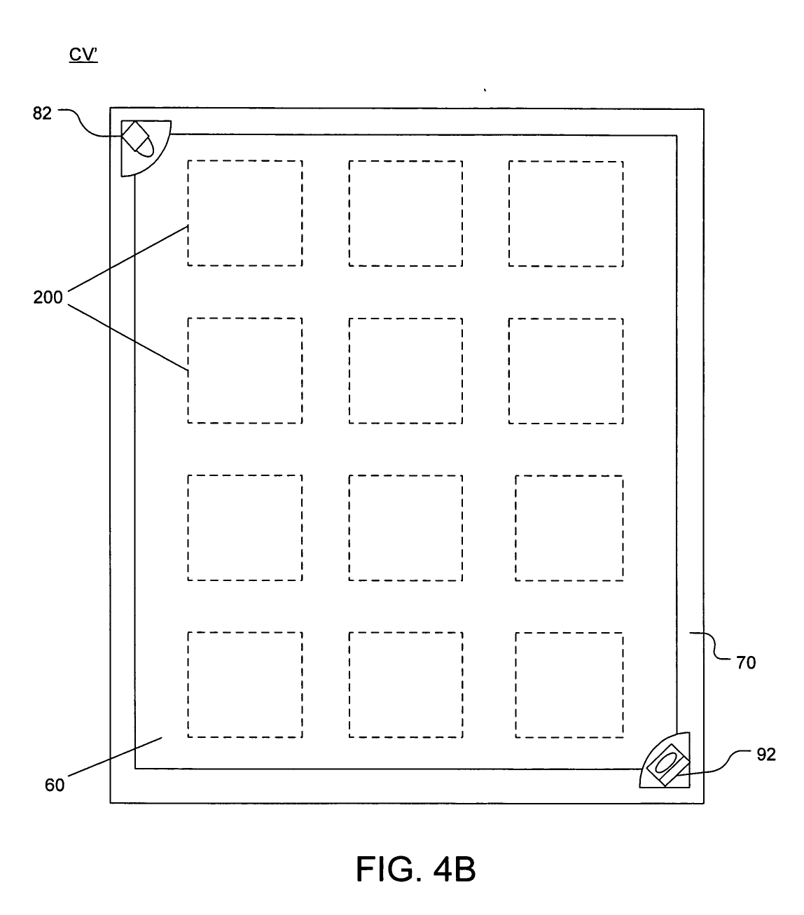

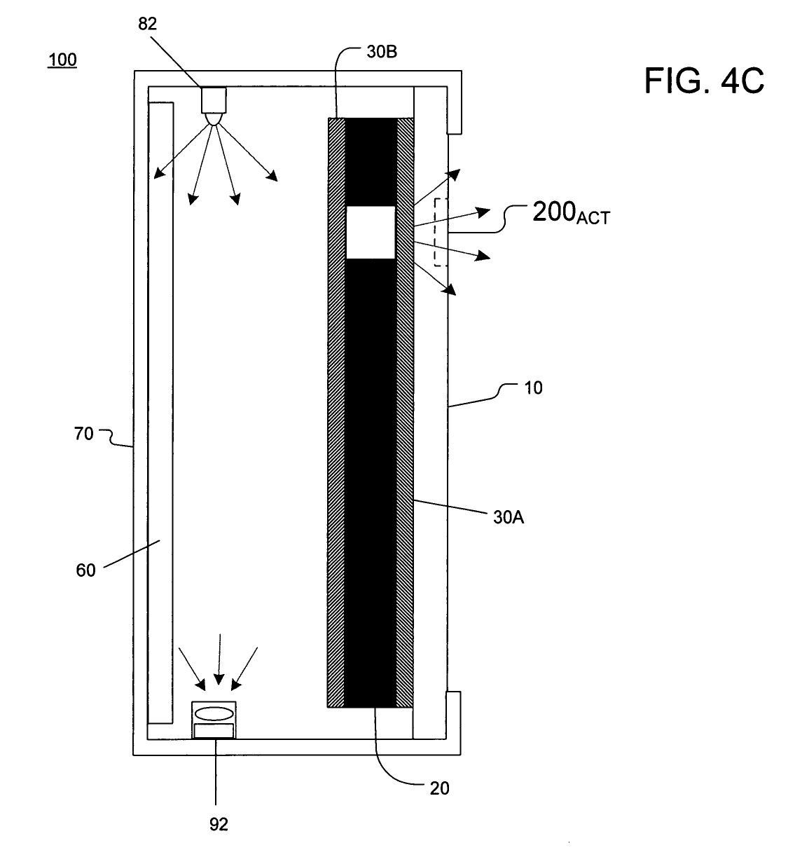

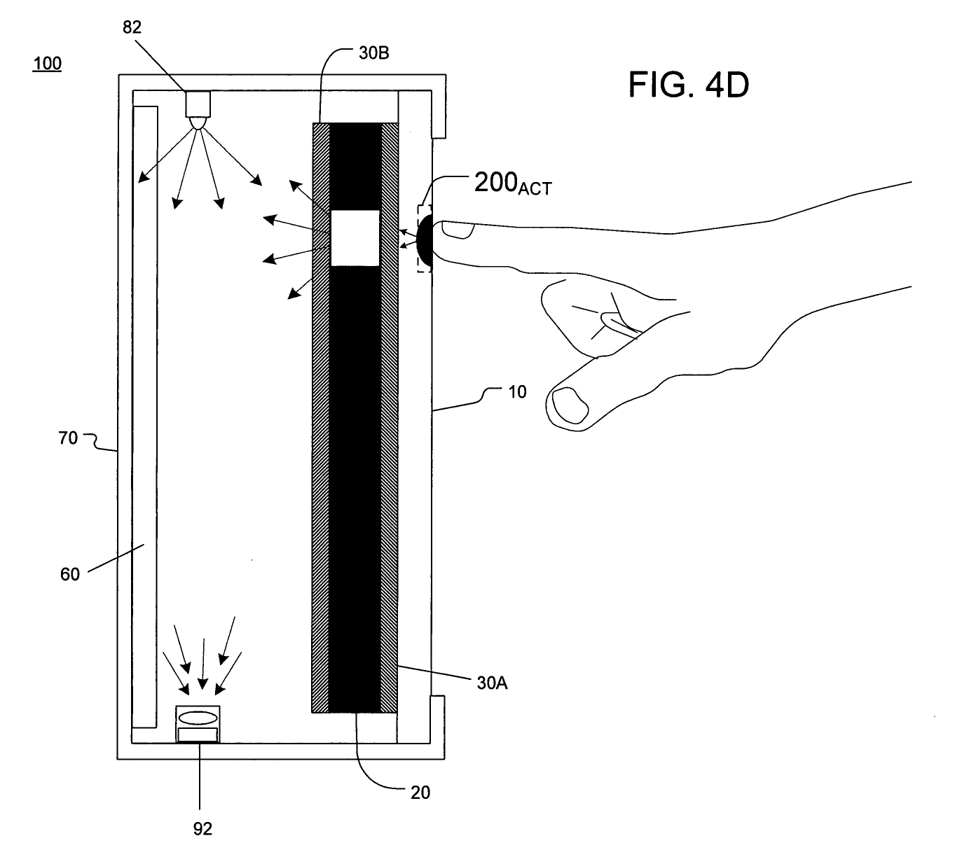

FIGS. 4A and 4B illustrate a particular exemplary embodiment of the present invention in which both the probe light source and sensor are disposed within the LCD stack. Specifically, FIG. 4A illustrates a side view of the LCD stack in an LCD device 100, including the front surface 10 (or touchscreen surface), polarizers 30A and 30B, LC layer 20, and reflective surface 60. FIG. 4B illustrates a planar view of the device 100 at cross-section CV′ of FIG. 4A.

It should be noted that principles of the present invention may be applied in both backlit (transmissive) and reflective-type LCD devices. However, even though the LCD device 100 illustrated in FIGS. 4A and 4B may be configured as a backlit LCD, these figures do not illustrate the backlight source as part of the LCD stack as a matter of convenience.

As shown in FIGS. 4A and 4B, the probe light source 82 may be a “pinpoint” light source, such as an LED. However, these figures are merely illustrative, and other types of probe light sources 82 may be used as will be contemplated by those of ordinary skill in the art.

According to the embodiment of FIGS. 4A and 4B, the probe light source 82 and probe light sensor 92 are disposed within the LCD stack, behind the LC layer 20 and polarizers 30A and 30B. Thus, as shown in FIG. 4A, the casing 70 and touchscreen surface 10 form an enclosure for the probe light source 82 and sensor 92, as well as other layers of the LCD stack.

A key feature of this particular embodiment is that the probe light source 82 and sensor 92 are implemented behind the LC layer 20. Otherwise, the positioning of probe light source 82 and sensor 92 in these figures are merely illustrative, and may be modified based on various design considerations as will be contemplated by those of ordinary skill in the art. For example, although the probe light source 82 and sensor 92 as being positioned at opposite corners in FIG. 4B, these elements could be positioned on the same side and/or closer to the center of the device 100.

FIGS. 4C and 4D illustrate the principles of operation of this device 100. According to an exemplary embodiment, the touchscreen keys 200 are made “active” one at a time. To do this, the LC layer 20 may be partitioned according to the touchscreen keys 200, similar to the touchscreen surface. By default, each partitioned area of the LC layer 20 may be configured to absorb the probe light transmitted by source 82. When a particular key 200 is made active, the LC layer may be configured to provide an “opening” in the corresponding partition to allow the probe light to pass through to the touchscreen surface, as illustrated in FIG. 4C.

FIG. 4C illustrates a particular situation where the LC layer 20 provides the probe light opening for an active touchscreen key 200_{ACT}, which is not currently touched by the user. As shown in this figure, the probe light sensor 92 will sense some amount of probe light transmitted by the probe light source 82. On the other hand, FIG. 4D illustrates the situation where the same touchscreen key 200_{ACT} is made active, and the active key 200_{ACT} is being touched by a user. In FIG. 4D, the user contact causes a reflection of the probe light back into the LCD stack, thus causing the measured intensity to increase at the probe light sensor 92. Based on this increased intensity measurement, the probe light sensor 92 can detect user contact with the touchscreen surface. Furthermore, since only one touchscreen key 200_{ACT} is active at this particular time, it can be determined which of the plurality of touchscreen keys 200 is touched by the user.

As described above, the probe light sensor 92 is placed within the LCD stack of the LCD device 100, along with the probe light source 82. Accordingly, the probe light sensor 92 must rely on the probe light to be reflected back through the probe light opening in order to detect user contact with the touchscreen surface. Since the probe light passes through the LC layer 20 twice, the signal strength is reduced.

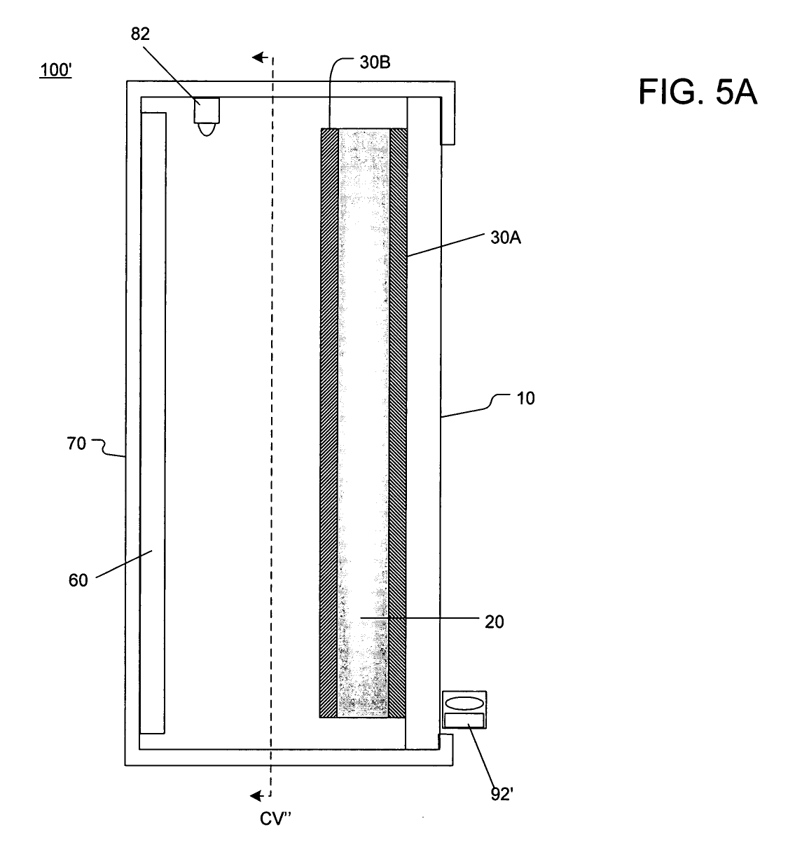

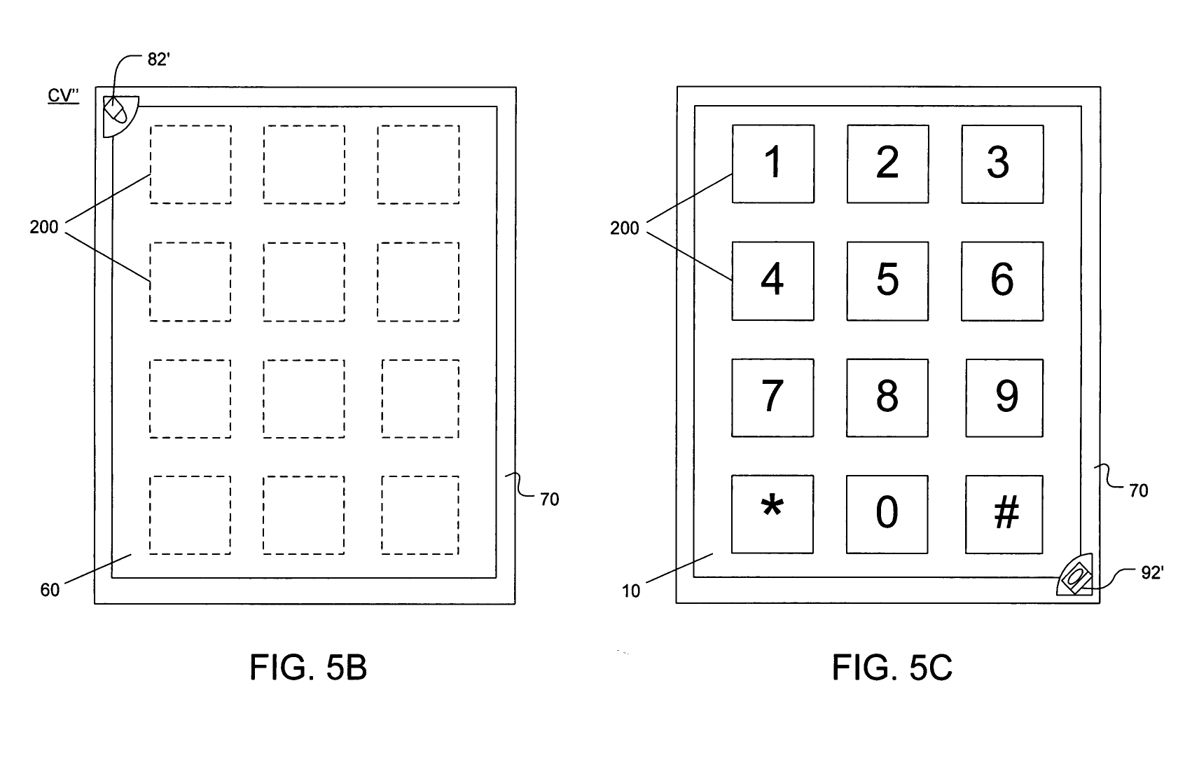

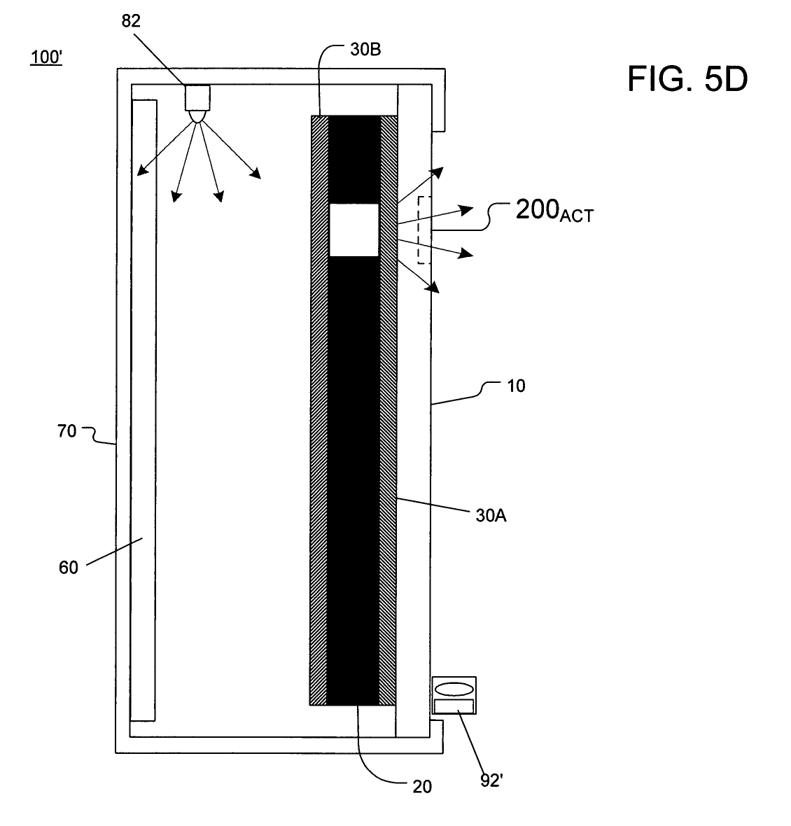

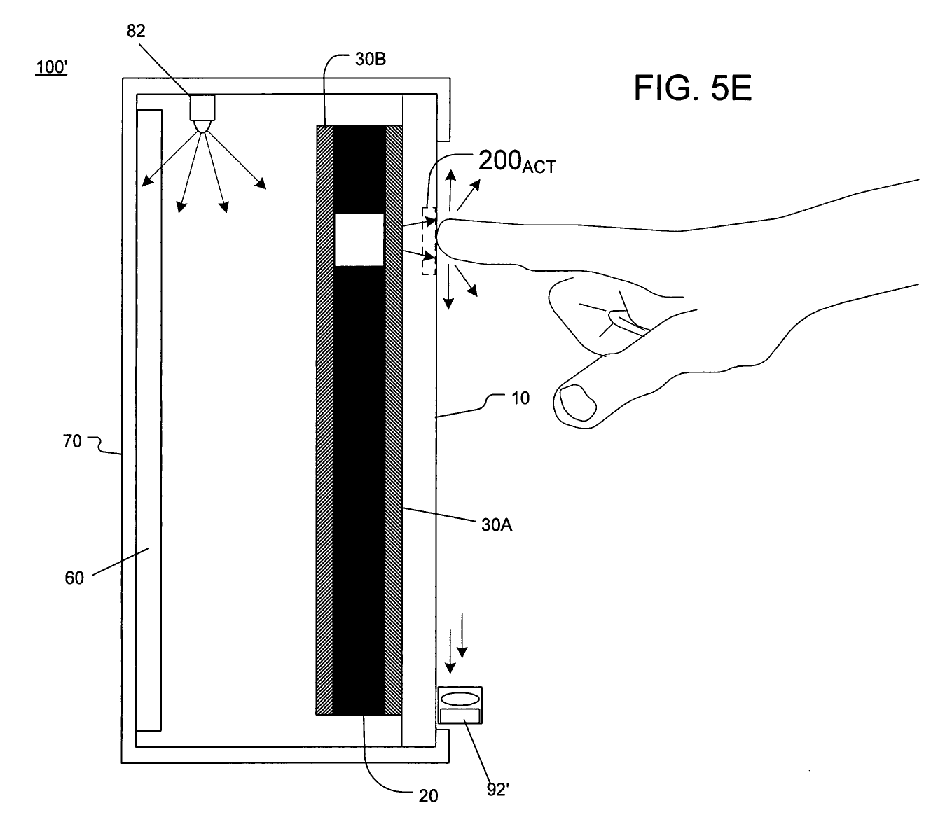

Thus, an alternative exemplary embodiment provides an external probe light sensor in order to increase the strength of the probe signal used for detecting user contact. Particularly, FIGS. 5A-5C illustrate an LCD device 100′, according to this alternative embodiment.

As shown in FIG. 5A, the probe light source 82 is placed within the LCD stack, behind the LC layer 20, similar to the other embodiment described above. However, in FIG. 5A, the probe light sensor 92′ is situated external to the touchscreen surface 10, near the edge of the surface. Thus, the probe light sensor is not disposed within the enclosure formed by casing 70 and touchscreen surface 10.

To further illustrate this, FIG. 5B illustrates a planar view of the device 100′ at cross section CV″ of FIG. 5A, showing that the probe light source 82 is not accompanied by the probe light sensor 92′ within the LCD stack. FIG. 5C illustrates an external planar view of the device 100′, which shows the probe light sensor 92′ being placed at or near the edge of touchscreen surface 10. Although FIGS. 5B and 5C illustrate the probe light source 82 and probe light sensor 92′ at the corners of the device 100′, this is merely exemplary. For instance, the probe light source 82 and sensor 92′ may be disposed closer to the center of any side of the device 100′.

FIGS. 5D and 5E illustrate the principles of operation of the device 100′ according to this alternative embodiment. Similar to the device 100 of FIGS. 4A-4D, the touchscreen keys 200 in device 100′ are made “active” one at a time, based on the operation of the LC layer 20. Particularly, in device 100′, a probe light opening scans through the partitions in the LC layer 20 that correspond to the touchscreen keys 200.

As such, FIG. 5D illustrates the situation where the active key 200_{ACT} is not touched by the user. As such, the probe light passes through the touchscreen surface via key 200_{ACT}. On the other hand, FIG. 5E illustrates the situation where the user is touching the active key 200_{ACT}. As shown in FIG. 5E, some of the probe light passing through the probe light opening will be scattered or reflected by the touch toward the external edges of the touchscreen surface. Thus, the measured intensity of probe light at the probe light sensor 92′ will increase, there by indicating that the user is touchscreen is being touched. Furthermore, given the position of the probe light opening at the time of detection, the device 100′ can determine the particular touchscreen key 200_{ACT} being touched.

The operation of the LC layer 20 in providing the probe light opening to the active key 200_{ACT} will be described below with respect to an exemplary embodiment. It should be noted that, unless specified otherwise, the following description applies to both types of device 100 and 100′ described above in connection with FIGS. 4A-4D and FIGS. 5A-5E, respectively.

During operation, the LCD device 100, 100′ alternates between a normal backlight display mode and touchscreen mode in an interleaved manner. In normal display mode, the LCD device 100, 100′ may display the contents of the touchscreen interface (keys 200, etc.). For instance, if the LCD device 100, 100′ is transmissive (backlit), the backlight sources may be used for displaying such contents.

During touchscreen mode, however, each partitioned area of the LC layer 20 may be, by default, opaque so that it does not transmit or reflect light. However, as each key 200 is made active, the corresponding partition of the LC layer 20 is switched from being opaque to transparent, thereby allowing the corresponding probe light source 82 to transmit through. Thus, as each partition of the LC layer 20 becomes transparent, it creates a probe light opening for the corresponding touchscreen key 200. The probe light opening scans through the LC layer partitions according to the scanning or timesharing process by which the touchscreen keys 200 are to be made active.

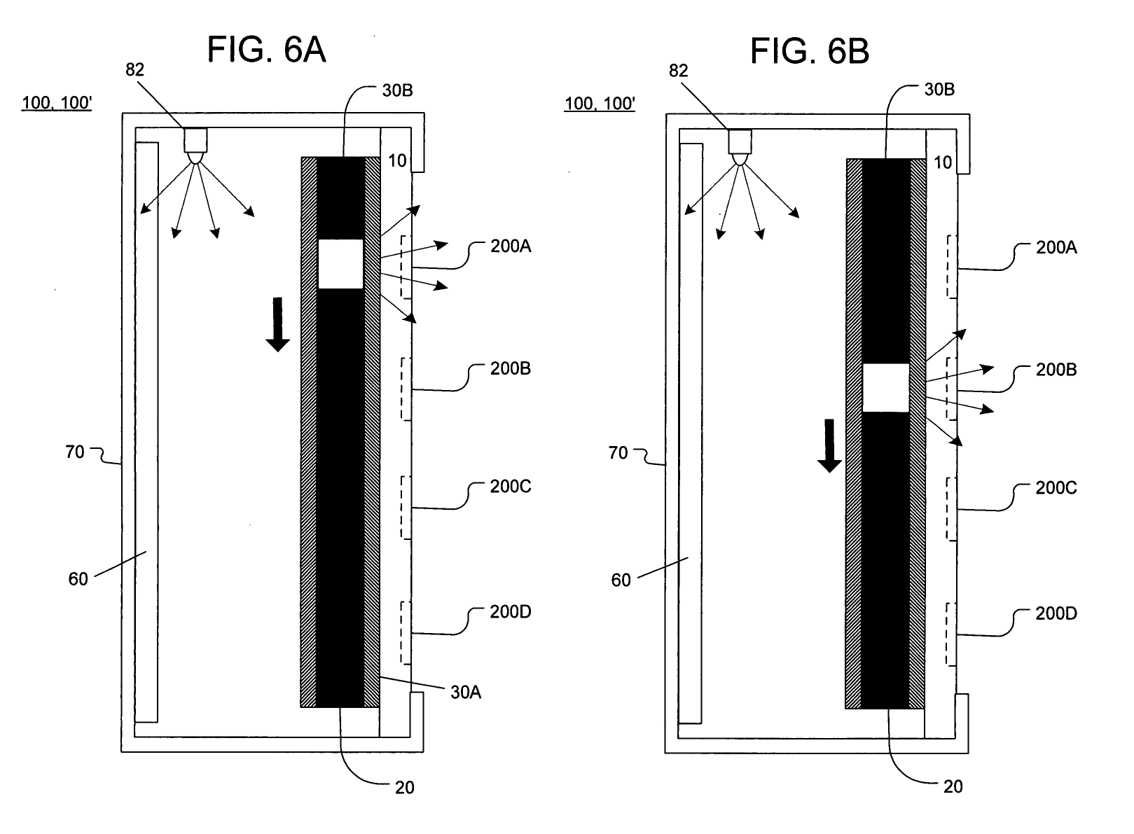

FIGS. 6A and 6B illustrate the scanning of the probe light opening through the touchscreen keys 200, according to an exemplary embodiment. For purposes of example, FIGS. 6A and 6B illustrate a situation where touchscreen keys 200A-200D are sequentially made active. In FIG. 6A, the LC layer 20 first provides the probe light opening to the partition corresponding to touchscreen key 200A. This allows the probe light to transmit through key 200A, thus making the key 200A active. FIG. 6B shows the next scanning interval, during which the probe light opening shifts to the partition of LC layer 20 corresponding to touchscreen key 200B. Thus, touchscreen key 200B is made active in FIG. 6B. In the next scanning interval, as illustrated by the arrow in 6B, the probe light opening will shift in order to make key 200C active, and so on.

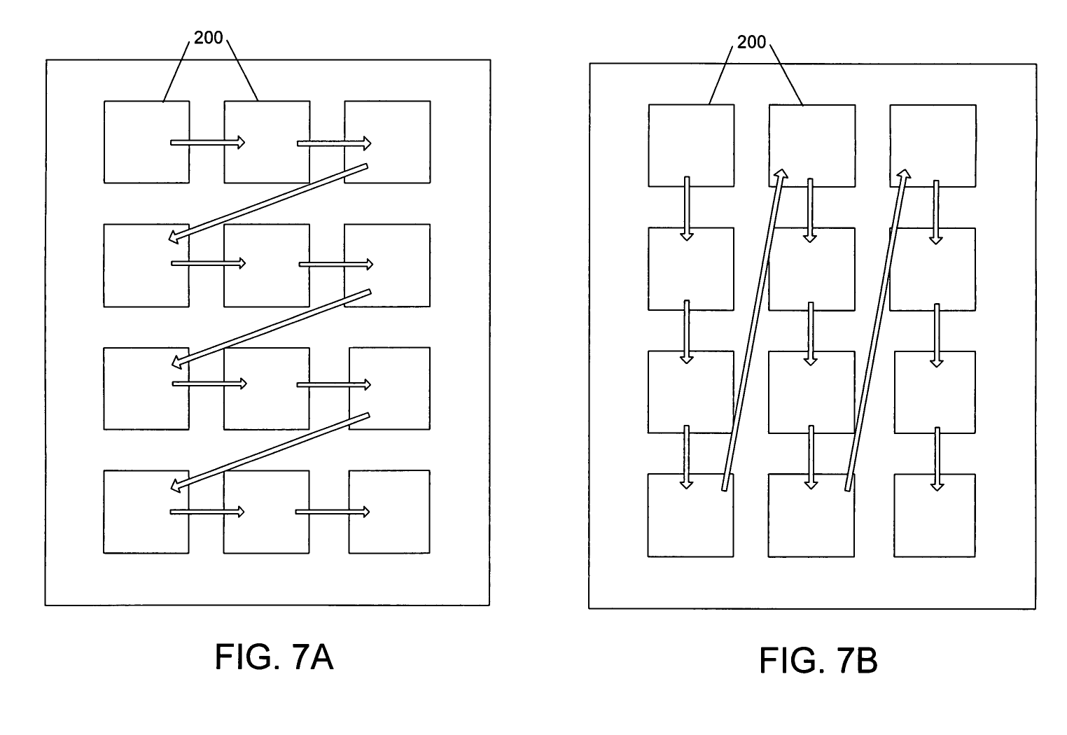

According to an exemplary embodiment, during touchscreen mode, only one key 200 on the touchscreen surface is active at a given time. For example, in the touchscreen application in FIG. 3, the probe light opening may scan through the touchscreen keys 200 according to the sequence or pattern illustrated in either FIG. 7A or FIG. 7B.

Of course, FIGS. 7A and 7B are provided for illustration only, and other scanning patterns may be implemented. Furthermore, it is not necessary for all the keys 200 to be scanned through during one cycle of the touchscreen mode. Since the interleaving rate between normal display mode and touchscreen mode is assumed to be relatively high, it is possible to allow the probe signal to scan through all of the touchscreen keys 200 over a plurality of touchscreen mode cycles. For example, it is contemplated that an interleaving rate of 60, 90, or 120 Hz could be used.

If the LCD device 100 is backlit, it would be advantageous for the probe light sensor 92, 92′ to be able to discriminate the probe light from the backlight. According to an exemplary embodiment, this can be done by using a different spectrum probe light source 82 than the backlight source(s). For instance, the probe light source 82 may be operated near or at infrared (IR) frequency. In such an embodiment, both the probe light source 82 and the backlight source(s) may remain on during normal display mode and touchscreen mode.

However, alternative embodiments of the invention may make it unnecessary to use a probe light and backlight at different frequencies, based on the interleaving of normal display and touchscreen modes. For example, in one different embodiment, the probe light and backlight may have the same spectrum, but be modulated at different frequencies.

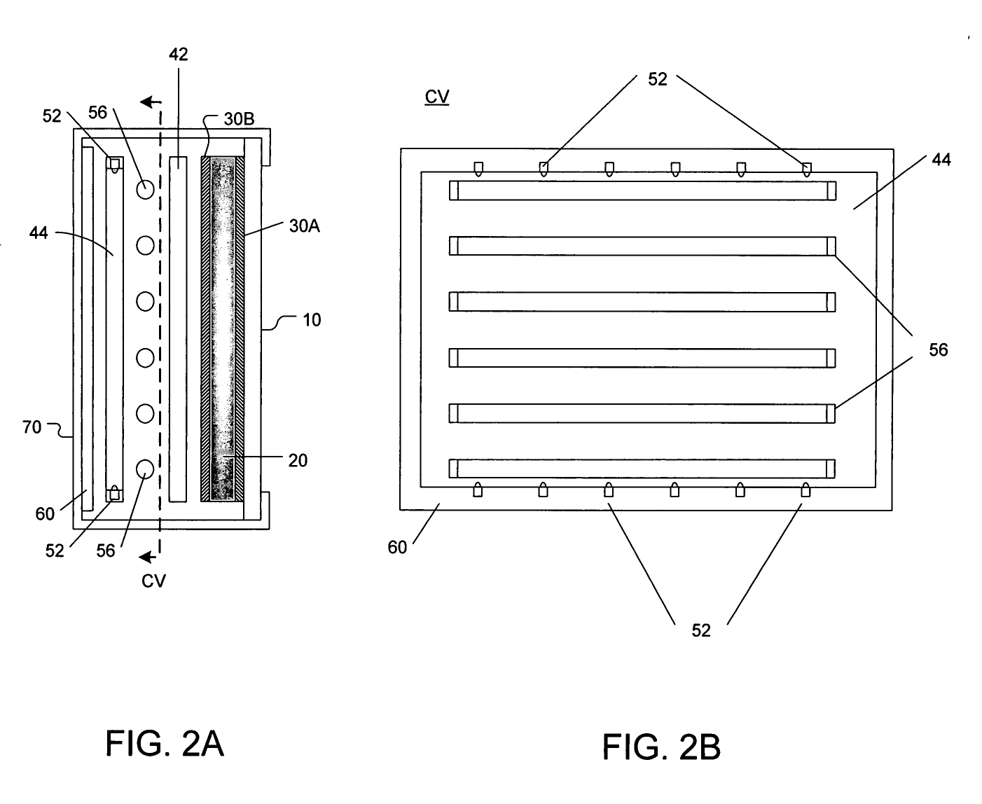

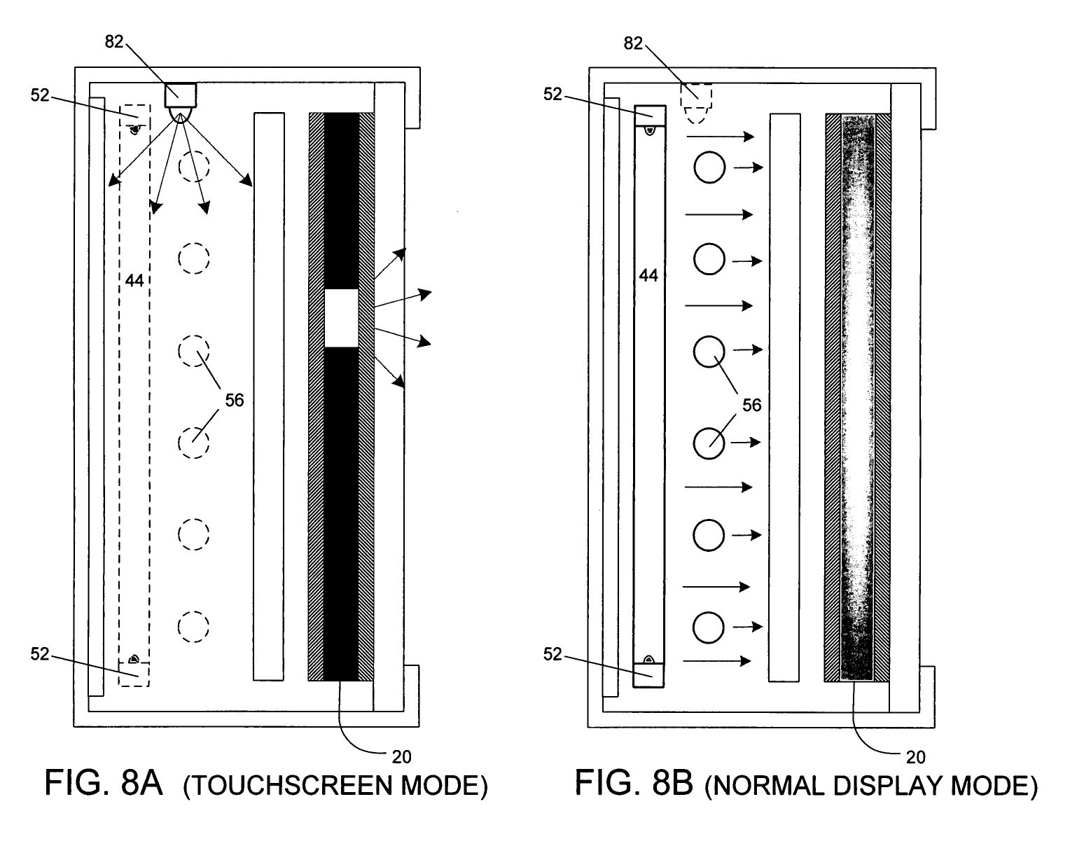

However, another embodiment takes advantage of the fact that the backlight source(s) are unneeded, and thus can be turned off, during touchscreen mode. This embodiment is illustrated in FIGS. 8A and 8B. For purposes of illustration, these figures illustrate an LCD device 100, 100′ utilizing backlight sources described above in connection with FIGS. 2A and 2B.

Specifically, FIG. 8A shows that only the probe light source 82 is operative during touchscreen mode, while backlight sources (LEDs 52 and CCFLs 56) are turned off (as illustrated by dotted lines), during touchscreen mode. Thus, the probe light sensor 92 (not shown) only detects probe light during touchscreen mode. On the other hand, FIG. 8B shows that the backlight sources are operative during normal display mode, while the probe light source 82 is turned off (as illustrated by dotted lines).

Even with the interleaved modes, however, it might be necessary to configure the probe light source 82 so that the probe light is more easily distinguished from other light sources (e.g., ambient light). Thus, in an exemplary embodiment, the probe light source 82 may be modulated at a particular frequency that helps distinguish it from other sources. This may be useful, e.g., for a reflective-type 100, 100′.

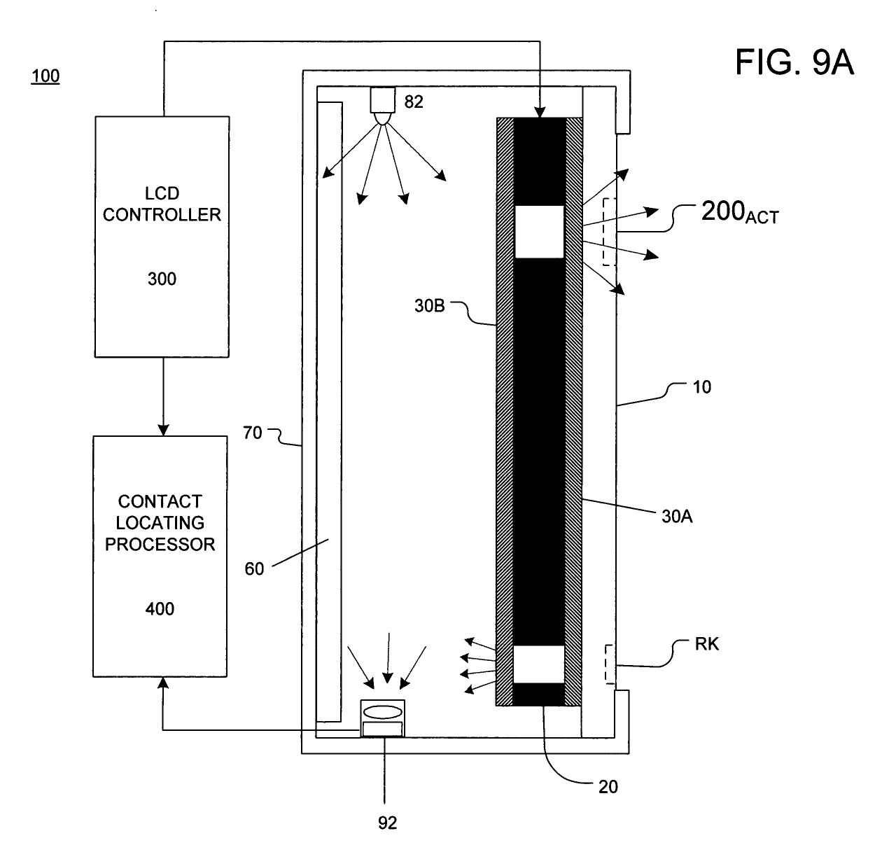

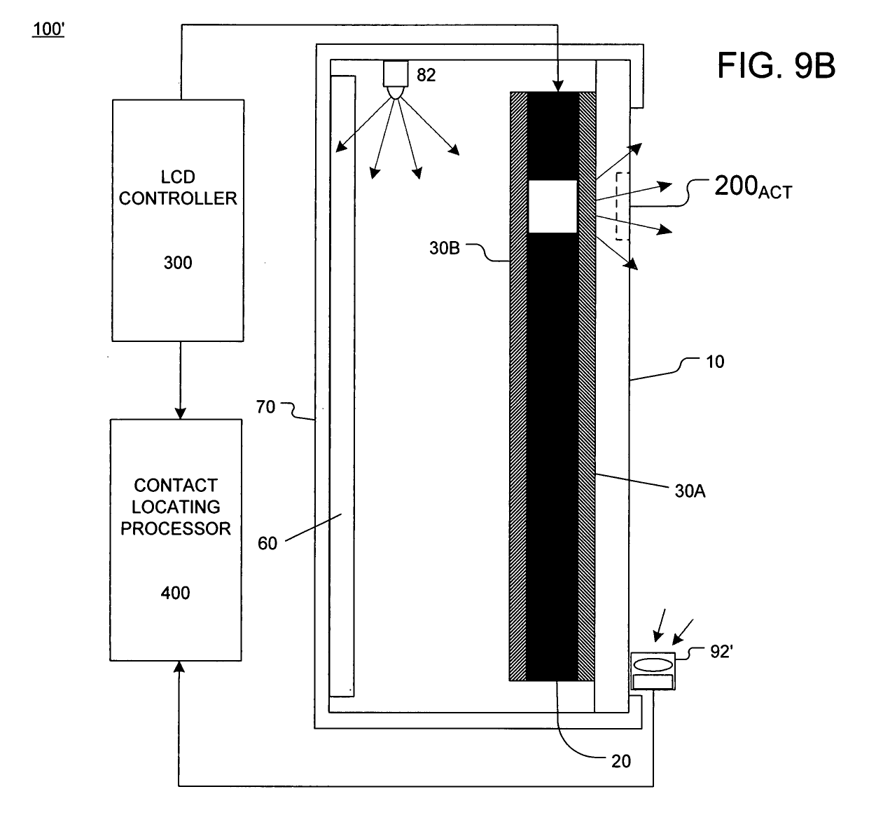

As discussed above, user contact with a particular touchscreen key 200 may be detected when the corresponding probe light sensor 92, 92′ measures an intensity level of the probe light (reflected from the touchscreen surface) that exceeds a certain threshold. For instance, the LCD device 100, 100′ may include a contact locating processor 400 designed to receive intensity measurements from the probe light sensor 92, 92′ and compare them to the appropriate threshold. This is illustrated in FIGS. 9A and 9B.

Specifically, FIG. 9A illustrates a contact locating processor 400 for use with an LCD device 100 having an internal probe light sensor 92 (as shown in FIGS. 4A-4D). FIG. 9B illustrates a contact locating processor 400 for use with an LCD device 100′ having an external probe light sensor 92′ (as shown in FIGS. 5A-5E). In FIGS. 9A and 9B, reference is also made to an LCD controller 300, which controls the operation of the LC layer 20.

As each key 200 becomes active during touchscreen mode according to the control of LCD controller 300, the probe light sensor 92, 92′ measures the intensity of probe light and sends the measurement to the contact locating processor 400. The contact locating processor 400 determines whether each measurement exceeds the threshold. The contact locating processor 400 is also notified by the LCD controller 300 as to the current position of the probe light opening in the LC layer 20. Thus, when a measured intensity exceeds the threshold, the contact locating processor 400 may correlate the received measurement to the position of the probe light opening in the LC layer 20, in order to determine which touchscreen key 200 was active at the time of the measurement. Thus, contact locating processor 400 is able to determine which particular key 200 has been touched by the user.

For an LCD device 100 utilizing an internal probe light sensor 92, the performance of the contact locating processor 400 may be improved through the use of “reference key.” An example of a reference key RK in such a device 100 is illustrated in FIG. 9A. As such, the LC layer 20 provides a transparent opening corresponding to the location of the reference key RK. For instance, reference key RK may allow the contact locating processor 400 may adjust the threshold(s) corresponding to the probe light sensors 92, e.g., to compensate for the movement of the bias point of the probe light sensors 92. However, as an alternative to adjusting the threshold, the contact locating processor 400 may be designed to differentially process the intensity measurements to make the necessary compensation. According to the exemplary embodiment, the size and shape of the transparent opening in the LC layer for reference key RK should be of a similar size and shape as the probe light opening for the active touchscreen key 200.

Exemplary embodiments having been described above, it should be noted that such descriptions are provided for illustration only and, thus, are not meant to limit the present invention as defined by the claims below. Any variations or modifications of these embodiments, which do not depart from the spirit and scope of the present invention, are intended to be included within the scope of the claimed invention.

For example, when a large number of touchscreen keys 200 are provided, it may be advantageous to allow multiple active probe signals to simultaneously scan through the keys 200. To do this, the touchscreen interface may be divided into separate partitions, each corresponding to a group or “block” of keys 200. Each partition may have its own probe light source and detector. This would allow touchscreen keys 200 in the respective partitions to simultaneously be made active during touchscreen mode. For instance, each probe light opening may scan through the keys 200 in the corresponding partition according to the pattern illustrated in FIG. 7A or 7B.

What is claimed is:

1. A liquid crystal display (LCD) device, comprising:
a transparent touchscreen surface, at least part of which is partitioned according to touchscreen keys;
a casing configured to hold the transparent touchscreen surface in place, such that the casing and touchscreen surface are configured to provide an enclosure for:
a liquid crystal (LC) layer disposed behind the touchscreen surface, and
a probe light source disposed behind the LC layer, the light source being configured to transmit a probe light through the touchscreen surface; and
a probe light sensing device configured to detect user contact with any of the touchscreen keys based on a reflection of the probe light,
wherein the LC layer is configured to selectively provide a probe signal opening for each of the touchscreen keys.

2. The LCD device of claim 1, wherein the probe light sensing device is disposed within the enclosure behind the LC layer.

3. The LCD device of claim 1, wherein the probe light sensing device is disposed outside the enclosure at the periphery of the touchscreen surface.

4. The LCD device of claim 1, wherein the probe light source is a light-emitting diode (LED).

5. The LCD device of claim 1, wherein the LCD device includes a backlight source configured to transmit backlight through the touchscreen surface to convey information to a user.

6. The LCD device of claim 5, wherein the backlight source comprises a plurality of light-emitting diodes (LEDs) including the probe light source.

7. The LCD device of claim 1, wherein the probe light source is configured to emit the probe light in the infrared range.

8. The LCD device of claim 1, wherein the LCD device is configured to operate according to the following interleaved modes: a normal display mode and a touchscreen mode.

9. The LCD device of claim 8, wherein
at least part of the LC layer is partitioned according to the touchscreen keys, and
each LC layer partition is configured to be selectively transparent and opaque during touchscreen mode, such that
the LC layer partition is transparent while the corresponding touchscreen key is active, thereby providing a probe light opening for the corresponding touchscreen key; and
the LC layer partition is opaque while the corresponding touchscreen key is inactive.

10. The LCD device of claim 9, wherein the LC layer partitions are configured to provide the probe light opening to the touchscreen keys according to a timesharing scheme during touchscreen mode.

11. The LCD device of claim 10, wherein user contact with a particular touchscreen key is detected when a measured intensity at the corresponding probe light sensor exceeds a predetermined threshold while the touchscreen key is active.

12. The LCD device of claim 11, wherein the probe light sensing device is disposed within the enclosure behind the LC layer, such that the probe light sensing device is configured to sense a reflection of the probe light from the point of user contact at the active touchscreen key back through the LC layer.

13. The LCD device of claim 11, wherein the probe light sensing device is disposed outside the enclosure at the periphery of the touchscreen surface, such that the probe light sensing device is configured to sense a reflection of the probe light from the point of user contact at the active touchscreen key to the periphery.

14. A liquid crystal display (LCD) device, comprising:
a transparent touchscreen surface, at least part of which is partitioned according to touchscreen keys;
a casing configured to hold the transparent touchscreen surface in place, such that the casing and touchscreen surface are configured to provide an enclosure for:
a liquid crystal (LC) layer disposed behind the touchscreen surface,
a probe light source disposed behind the LC layer, the light source being configured to transmit a probe light through the touchscreen surface, and
a probe light sensing device disposed behind the LC layer, the probe light sensing device being configured to detect user contact with any of the touchscreen keys based on a reflection of the probe light,
wherein the LC layer is configured to selectively provide a probe signal opening for each of the touchscreen keys.

15. The LCD device of claim 8, wherein
at least part of the LC layer is partitioned according to the touchscreen keys,
the LCD device is configured to operate according to the following interleaved modes: a normal display mode and a touchscreen mode, and
each LC layer partition is configured to be selectively transparent and opaque during touchscreen mode, such that
the LC layer partition is transparent while the corresponding touchscreen key is active, thereby providing a probe light opening for the corresponding touchscreen key; and
the LC layer partition is opaque while the corresponding touchscreen key is inactive.

16. The LCD device of claim 15, wherein the LC layer partitions are configured to provide the probe light opening to the touchscreen keys according to a timesharing scheme during touchscreen mode.

17. The LCD device of claim 10, wherein user contact with a particular touchscreen key is detected when a measured intensity at the corresponding probe light sensor exceeds a predetermined threshold while the touchscreen key is active.

18. A liquid crystal display (LCD) device, comprising:
a transparent touchscreen surface, at least part of which is partitioned according to touchscreen keys;
a casing configured to hold the transparent touchscreen surface in place, such that the casing and touchscreen surface are configured to provide an enclosure for:
a liquid crystal (LC) layer disposed behind the touchscreen surface, and
a probe light source disposed behind the LC layer, the light source being configured to transmit a probe light through the touchscreen surface; and
a probe light sensing device disposed outside the enclosure at the periphery of the touchscreen surface, the probe light sensing device being configured to detect user contact with any of the touchscreen keys based on a reflection of the probe light from the point of user contact to the periphery,
wherein the LC layer is configured to selectively provide a probe signal opening for each of the touchscreen keys.

19. The LCD device of claim 18, wherein
at least part of the LC layer is partitioned according to the touchscreen keys,
the LCD device is configured to operate according to the following interleaved modes: a normal display mode and a touchscreen mode, and
each LC layer partition is configured to be selectively transparent and opaque during touchscreen mode, such that
the LC layer partition is transparent while the corresponding touchscreen key is active, thereby providing a probe light opening for the corresponding touchscreen key; and
the LC layer partition is opaque while the corresponding touchscreen key is inactive.

20. The LCD device of claim 18, wherein
the LC layer partitions are configured to provide the probe light opening to the touchscreen keys according to a timesharing scheme during touchscreen mode, and
user contact with a particular touchscreen key is detected when a measured intensity at the corresponding probe light sensor exceeds a predetermined threshold while the touchscreen key is active.
